(19) United States
(12) Patent Application Publication
(10) Pub. No.: US 2026/0065138 A1
(43) Pub. Date: Mar. 5, 2026

(54) SYSTEMS AND METHODS FOR LINKING DATA ELEMENTS USED BY DIFFERENT SERVICES

(71) Applicant: JPMORGAN CHASE BANK, N.A., New York, NY (US)

(72) Inventors: Shankaranarayanan KALYANARAMAN, Plano, TX (US); John ZIMNOX, Columbus (OH); Mark MORAWSKI, Prosper, TX (US); Amit CHAND, Frisco, TX (US); Vish V PATIL, Bear, DE (US)

(21) Appl. No.: 18/824,335

(22) Filed: Sep. 4, 2024

(51) Int. Cl. G06N 20/00

(52) U.S. Cl. CPC G06N 20/00

(57) ABSTRACT

A method may include: collecting application programming interface (API) datasets, each API dataset identifying data elements used by the API, descriptions of the data elements, and datatypes for the data elements; splitting the API datasets into a training API dataset and a validation API dataset; labeling the data elements in the training API dataset using standard data elements that are defined by an organization for use by the organization; training a machine learning model with the training API dataset and the labels, wherein the machine learning model is trained to match the data elements to the standard data element; and integrating the machine learning model into a workflow, The machine learning model matches a non-standard data element in a new API dataset to one of the standard data elements. A downstream system uses the non-standard data element in the same manner as the matching standard data element.

### BACKGROUND OF THE INVENTION

### 1. Field of the Invention

Embodiments generally relate to systems and methods for linking data elements used by different services.

### 2. Description of the Related Art

Organizations use a number of application programming interfaces (APIs) to enable their systems to interact with both internal and external systems. While organizations generally have control over the properties of the data elements used by their APIs-such as data element names and values-challenges arise when interfacing with external systems. Differences in data element names and formats can necessitate manual mapping of internal data elements to those of external systems. As the number of external systems increases, manual mapping becomes impractical and error-prone.

### SUMMARY OF THE INVENTION

Systems and methods for linking data elements used by different services are disclosed. In one embodiment, a method may include: (1) collecting, by a computer program executed by an electronic device, a plurality of application programming interface (API) datasets, each API dataset identifying data elements used by the API, descriptions of the data elements, and datatypes for the data elements; (2) splitting, by the computer program, the API datasets into a training API dataset and a validation API dataset; (3) labeling, by the computer program, the data elements in the training API dataset using standard data elements, wherein the standard data elements are defined by an organization for use by the organization; (4) training, by the computer program, a machine learning model with the training API dataset and the labels, wherein the machine learning model may be trained to match the data elements to the standard data element; (5) evaluating, by the computer program, the machine learning model using the validation API dataset; and (6) integrating, by the computer program, the machine learning model into a workflow, wherein the machine learning model may be configured to match a non-standard data element in a new API dataset to one of the standard data elements; wherein a downstream system may be configured to use the non-standard data element in the same manner as the matching standard data element.

In one embodiment, the API datasets are collected from a plurality of different industries.

In one embodiment, the method may also include: pre-processing, by the computer program, the API dataset by extracting, for each data element, a data element name, the description, and the datatype.

In one embodiment, the machine learning model may be evaluated for precision, recall, and/or F1 score.

In one embodiment, the method may also include: creating, by the computer program, one or more algorithm to match the non-standard data elements to standard data elements using the machine learning model.

In one embodiment, the method may also include: receiving, by the computer program and from a user interface, a query for a mapping of one of the data elements to other data elements; identifying, by the computer program, one of the standard data elements that matches the data element in the query; retrieving, by the computer program, the other data elements that are matched to the identified standard data element; and displaying, by the computer program, a mapping of the other data elements and the data element that are matched to the identified data element.

In one embodiment, the method may also include: prompting, by the computer program, a large language model for a name for the non-standard data element, the prompt comprising the non-standard data element and the description for the matching standard data element; and receiving, from the large language model, the name for the non-standard data element.

According to another embodiment, a system may include: a data source for a plurality of application programming interface (API) datasets, each API dataset identifying data elements used by the API, descriptions of the data elements, and datatypes for the data elements; a computer program executed by an electronic device that may be configured to split the API datasets into a training API dataset and a validation API dataset, to label the data elements in the training API dataset using standard data elements, wherein the standard data elements are defined by an organization for use by the organization, to train a machine learning model with the training API dataset and the labels, wherein the machine learning model may be trained to match the data elements to the standard data element, to evaluate the machine learning model using the validation API dataset, and to integrate the machine learning model into a workflow, wherein the machine learning model may be configured to match a non-standard data element in a new API dataset to one of the standard data elements; and a downstream system that may be configured to use the non-standard data element in the same manner as the matching standard data element.

In one embodiment, the API datasets are collected from a plurality of different industries.

In one embodiment, the computer program may be further configured to pre-process the API dataset by extracting, for each data element, a data element name, the description, and the datatype.

In one embodiment, the machine learning model may be evaluated for precision, recall, and/or F1 score.

In one embodiment, the computer program may be further configured to use one or more algorithm to match the non-standard data elements to standard data elements using the machine learning model.

In one embodiment, the computer program may be further configured to receive, from a user interface, a query for a mapping of one of the data elements to other data elements, to identify one of the standard data elements that matches the data element in the query, to retrieve the other data elements that are matched to the identified standard data element, and to display a mapping of the other data elements and the data element that are matched to the identified data element.

In one embodiment, the computer program may be further configured to prompt a large language model for a name for the non-standard data element, the prompt comprising the non-standard data element and the description for the matching standard data element, and to receive, from the large language model, the name for the non-standard data element.

According to another embodiment, a non-transitory computer readable storage medium may include instructions stored thereon, which when read and executed by one or more computer processors, cause the one or more computer processors to perform steps comprising: collecting a plurality of application programming interface (API) datasets, each API dataset identifying data elements used by the API, descriptions of the data elements, and datatypes for the data elements, wherein the API datasets are collected from a plurality of different industries; splitting the API datasets into a training API dataset and a validation API dataset; labeling the data elements in the training API dataset using standard data elements, wherein the standard data elements are defined by an organization for use by the organization; training a machine learning model with the training API dataset and the labels to match the data elements to the standard data element; evaluating the machine learning model using the validation API dataset; integrating the machine learning model into a workflow to match a non-standard data element in a new API dataset to one of the standard data elements; and using the non-standard data element in the same manner as the matching standard data element.

In one embodiment, the non-transitory computer readable storage medium may also include instructions stored thereon, which when read and executed by the one or more computer processors, cause the one or more computer processors to perform steps comprising: pre-processing the API dataset by extracting, for each data element, a data element name, the description, and the datatype.

In one embodiment, the machine learning model may be evaluated for precision, recall, and/or F1 score.

In one embodiment, the non-transitory computer readable storage medium may also include instructions stored thereon, which when read and executed by the one or more computer processors, cause the one or more computer processors to perform steps comprising: creating one or more algorithm to match the non-standard data elements to standard data elements using the machine learning model.

In one embodiment, the non-transitory computer readable storage medium may also include instructions stored thereon, which when read and executed by the one or more computer processors, cause the one or more computer processors to perform steps comprising: receiving, from a user interface, a query for a mapping of one of the data elements to other data elements; identifying one of the standard data elements that match the data element in the query; retrieving the other data elements that are matched to the identified standard data element; and displaying a mapping of the other data elements and the data element that are matched to the identified data element.

In one embodiment, the non-transitory computer readable storage medium may also include instructions stored thereon, which when read and executed by the one or more computer processors, cause the one or more computer processors to perform steps comprising: prompting a large language model for a name for the non-standard data element, the prompt comprising the non-standard data element and the description for the matching standard data element; and receiving, from the large language model, the name for the non-standard data element.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for linking data elements used by different services according to an embodiment;

FIG. 2 depicts a method for linking data elements used by different services according to an embodiment; and

FIG. 3 depicts an exemplary computing system for implementing aspects of the present disclosure.

### DETAILED DESCRIPTION OF PREFERRED EMBODIMENTS

Systems and methods for linking data elements used by different services are disclosed.

Embodiments may provide a data mapping tool that streamlines the data matching process through an interactive UI interface to connect data elements between APIs. It may ingest information about the APIs (e.g., structure, data element names, etc.) to record data elements and may use advance search technique to match data elements between various services using, for example, data element name, data element description, and data element types. Embodiments may enhance the mapping using artificial intelligence (AI)-based prediction.

Embodiments dynamically align data elements between internal and external systems, reducing the need for manual intervention and minimizing errors. Additionally, adopting industry-standard data interchange formats (such as JSON Schema, XML Schema, or OpenAPI) facilitates smoother integration by providing a common framework for data representation. These approaches enhance scalability and efficiency, allowing organizations to seamlessly integrate with a growing number of external systems.

Embodiments may generate a request/response translation and transformation configuration that can be consumed by a cloud provider gateway. This avoids developing a separate translation and transformation layer while providing more control to the product team to drive changes through configuration.

Embodiments may use a set of data elements that have been standardized for an organization, and may map non-standard data elements (e.g., data elements used by third parties) to the standard data elements. This enables the model to learn and identify standard data elements for incoming non-standard data elements in subsequent interactions. This results in improved accuracy and consistency in data element identification and data element mapping.

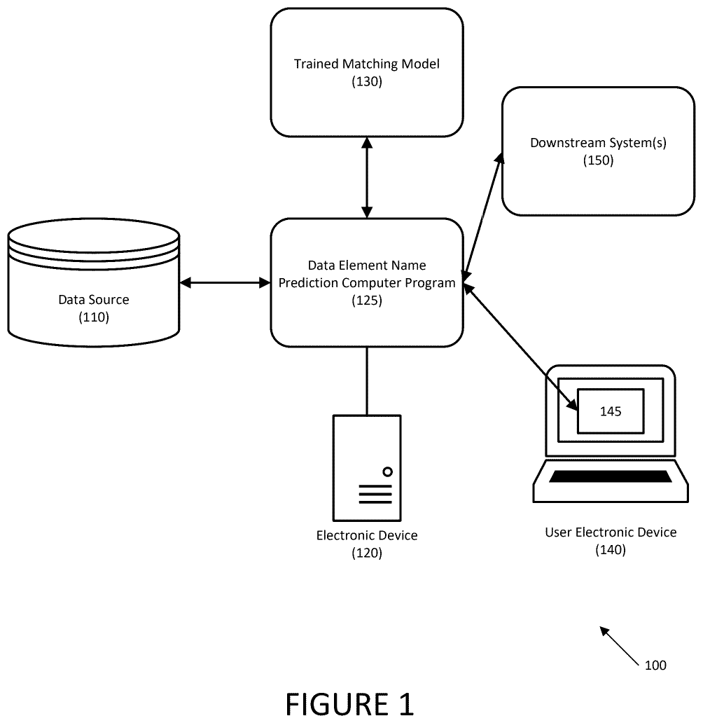

Referring to FIG. 1, a system for linking data elements used by different services is disclosed according to an embodiment. System 100 may include data source 110, such as a source of API data. The API data may identify data elements, data element descriptions, data element types, etc.

Data element name prediction computer program 125 may be executed by electronic device 120, which may be a server (e.g., physical and/or cloud-based), a computer (e.g., workstation, desktop, laptop, notebook, tablet, etc.), a smart device (e.g., smart phone, smart watch, etc.), an Internet of Things (IoT) appliance, etc. Data element name prediction computer program 125 may ingest API data from data source 110 and may use the ingested data to train trained matching model 130.

System 100 may further include user electronic device 140, which may be a computer, a smart device, an IoT appliance, etc. User electronic device 140 may execute user computer program 145 that may provide an interface to data element name prediction computer program 125. Using user computer program 145, a user may submit queries, such as data element name matching queries, to data element name prediction computer program 125, and using trained matching model 130, data element name prediction computer program 125 may return results including matching data elements used by APIs across the organization.

System 100 may further include one or more downstream system(s) 150. Downstream systems 150 may retrieve or otherwise access trained matching model 130, and may use trained matching model 130 to identify a standard data element that can be used when a non-standard data element is received. In another embodiment, trained matching model 130 may be integrated into downstream system(s) 150, and may be periodically updated.

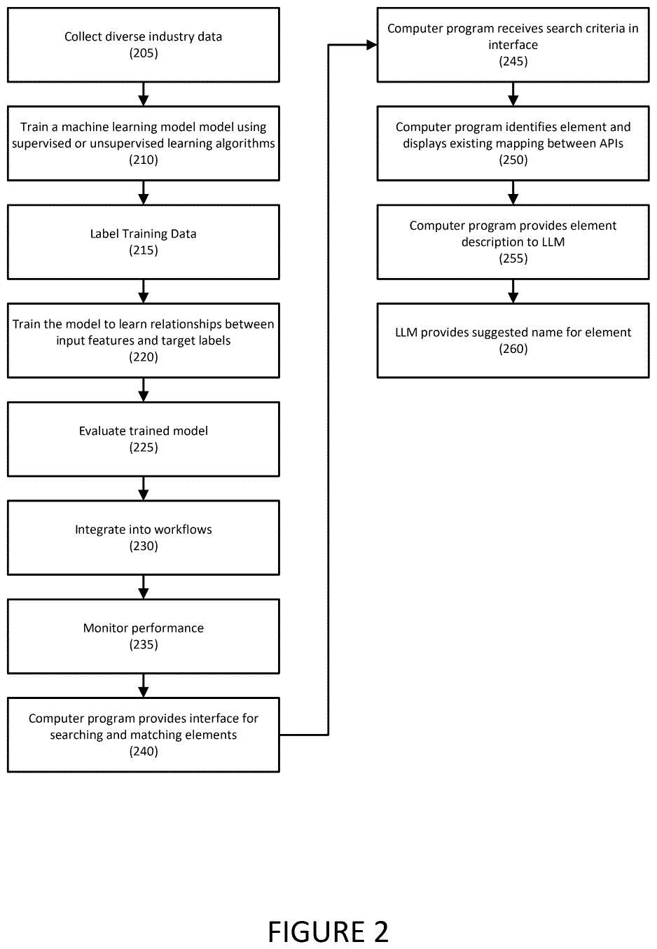

Referring to FIG. 2, a method for linking data elements used by different services is disclosed according to an embodiment.

In step 205, a computer program, such as a data element matching computer program for an organization, may collect and preprocess diverse industry data. For example, the computer program may collect data, such as a plurality of application programming interface (API) datasets, from a variety of industries, including healthcare, finance, manufacturing, retail, etc., that contains standard data definitions and elements. In one embodiment, each API dataset may identify data elements used by different APIs, their descriptions, and datatypes.

In one embodiment, the organization may define the standard data elements for use within the organization.

The computer program may also collect internal data dictionaries or documentation from these industries that describe non-standard elements defined by internal teams. For example, the organization may use a standard definition for elements used in its APIs, which ensures consistency, accuracy, and compliance across all data exchanges within the organization. In embodiments, the computer program may upload a file (e.g., a JSON file) comprising information from the organization, and may then parse the file to extract the data.

The computer program may also preprocess the data in the API datasets. For example, the computer program may extract relevant fields such as name, description, type, and enumeration values from the collected data, may normalize and clean the data to ensure consistency and remove any noise or irrelevant information, and may annotate the data to distinguish between standard and non-standard elements.

For example, the computer program may preprocess text data by converting text to lowercase; removing punctuation, special characters, and extra whitespaces; tokenizing the text into words; removing stopwords; stemming or lemmatizing words to reduce them their base forms; etc. It may then encode the target data element names into a numerical format as necessary.

The computer program may also extract relevant fields from the preprocessed text data using, for example, Bag of Words, Term Frequency Inverse Document Frequency (“TF-IDF”), word embeddings (e.g., Word2Vec, GloVe), BERT embeddings, etc. The text data may then be converted into numerical features that can be provided to a machine learning model.

In one embodiment, the relevant fields from the API datasets may be mapped to corresponding data governance-defined fields.

In embodiments, the API datasets may be split into a training API dataset and a validation API dataset (e.g., 70-80% for training and 20-30% for validation).

In step 210, the computer program may train a machine learning model using supervised (e.g., classification) or unsupervised learning (e.g., clustering) algorithms on the standard data elements. The input features may include, for example, data element name, data element description, data element type, enumeration values, etc.

In one embodiment, the training may be performed before the training data is labeled, and again after the training data is labeled.

In another embodiment, the training API dataset may be labeled before the training.

In one embodiment, a suitable machine learning model architecture for the task may be selected. In one embodiment, because this is a text and classification problem, natural language processing (NLP) techniques, such as transformer-based models (e.g., BERT, GPT, or ROBERTa, that are fine-tuned for classification) LSTM or GRU networks for sequential data processing, and classification algorithms like Random Forest, Gradient Boosting, or Support Vector Machines (SVMs).

In one embodiment, the machine learning model architecture may be manually selected.

The machine learning model may then be trained using the training API dataset, focusing on minimizing classification errors and maximizing accuracy in identifying the data governance-defined fields.

In step 215, the computer program may label the training API dataset with, for example, corresponding standard elements from various industries. For example, the computer program may label the training API dataset with the corresponding standard elements from the various industries.

In step 220, the computer program may train the ML model to learn relationships between the input features and target labels (e.g., for the standard elements).

In step 225, the computer program may evaluate the trained ML model using the validation data to assess the accuracy and performance of the ML model. The computer program may evaluate the ML model using metrics, such as precision, recall, and F1 score (i.e., the harmonic mean of precision and recall), to measure the model's effectiveness in mapping non-standard elements to standard elements.

In step 230, if the model meets an accuracy and performance standard, the computer program may integrate the trained ML model in one or more workflows. For example, the computer program may create algorithms to match non-standard elements in a new API dataset to corresponding standard elements based on similarity. Embodiments may also use natural language processing (NLP) techniques for accurate mappings.

Once matched, downstream systems may use the non-standard data element based on the matching with the standard data element.

For example, integration may be provided by an API that may allow internal teams to input non-standard elements and receive corresponding standard elements as the output.

In step 235, the computer program may monitor the performance of the ML model. For example, the computer program may receive feedback from users and may incorporate the feedback and new data to retrain the model periodically to improve accuracy and adapt to changes in internal standards and standard elements from various industries.

In step 240, the computer program may provide an interface for searching and matching data elements, and in step 245, the computer program may receive search criteria in the interface. For example, the computer program may receive a local data element name and/or a data element description.

In step 250, using the model, the computer program may identify corresponding data elements for the search criteria, and may display a mapping of the data element among different APIs. For example, the computer program may suggest a matching element for a new data element, and may then make the association if approved.

In step 255, the computer program may provide a data element description to a large language model, and in step 260, the LLM may provide a suggested name for the data element.

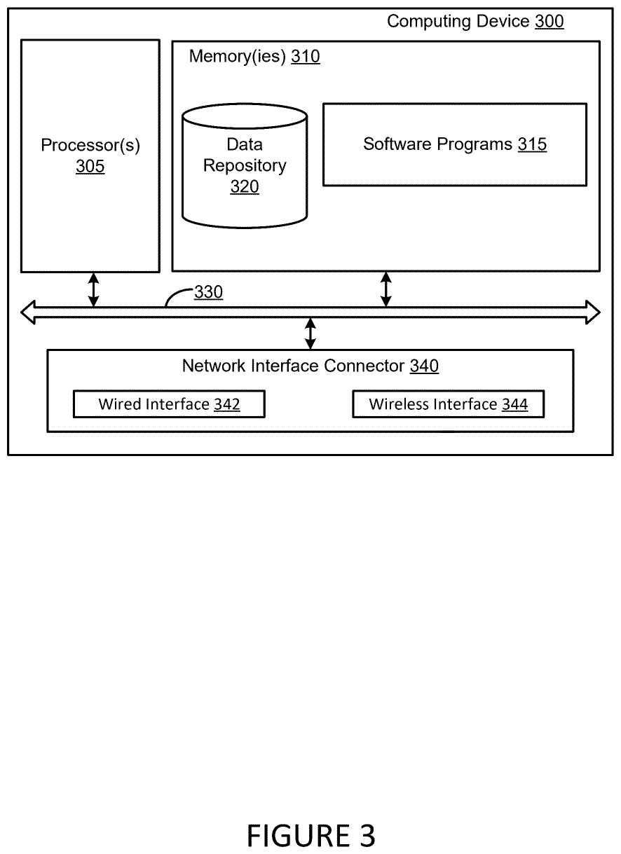

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments.

As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
collecting, by a computer program executed by an electronic device, a plurality of application programming interface (API) datasets, each API dataset identifying data elements used by the API, descriptions of the data elements, and datatypes for the data elements;
splitting, by the computer program, the API datasets into a training API dataset and a validation API dataset;
labeling, by the computer program, the data elements in the training API dataset using standard data elements, wherein the standard data elements are defined by an organization for use by the organization;
training, by the computer program, a machine learning model with the training API dataset and the labels, wherein the machine learning model is trained to match the data elements to the standard data element;
evaluating, by the computer program, the machine learning model using the validation API dataset; and
integrating, by the computer program, the machine learning model into a workflow, wherein the machine learning model is configured to match a non-standard data element in a new API dataset to one of the standard data elements;
wherein a downstream system is configured to use the non-standard data element in the same manner as the matching standard data element.

2. The method of claim 1, wherein the API datasets are collected from a plurality of different industries.

3. The method of claim 1, further comprising:
pre-processing, by the computer program, the API dataset by extracting, for each data element, a data element name, the description, and the datatype.

4. The method of claim 1, wherein the machine learning model is evaluated for precision, recall, and/or F1 score.

5. The method of claim 1, further comprising:
creating, by the computer program, one or more algorithm to match the non-standard data elements to standard data elements using the machine learning model.

6. The method of claim 1, further comprising:
receiving, by the computer program and from a user interface, a query for a mapping of one of the data elements to other data elements;
identifying, by the computer program, one of the standard data elements that matches the data element in the query;
retrieving, by the computer program, the other data elements that are matched to the identified standard data element; and
displaying, by the computer program, a mapping of the other data elements and the data element that are matched to the identified data element.

7. The method of claim 1, further comprising:
prompting, by the computer program, a large language model for a name for the non-standard data element, the prompt comprising the non-standard data element and the description for the matching standard data element; and
receiving, from the large language model, the name for the non-standard data element.

8. A system, comprising:
a data source for a plurality of application programming interface (API) datasets, each API dataset identifying data elements used by the API, descriptions of the data elements, and datatypes for the data elements;
a computer program executed by an electronic device that is configured to split the API datasets into a training API dataset and a validation API dataset, to label the data elements in the training API dataset using standard data elements, wherein the standard data elements are defined by an organization for use by the organization, to train a machine learning model with the training API dataset and the labels, wherein the machine learning model is trained to match the data elements to the standard data element, to evaluate the machine learning model using the validation API dataset, and to integrate the machine learning model into a workflow, wherein the machine learning model is configured to match a non-standard data element in a new API dataset to one of the standard data elements; and
a downstream system that is configured to use the non-standard data element in the same manner as the matching standard data element.

9. The system of claim 8, wherein the API datasets are collected from a plurality of different industries.

10. The system of claim 8, wherein the computer program is further configured to pre-process the API dataset by extracting, for each data element, a data element name, the description, and the datatype.

11. The system of claim 8, wherein the machine learning model is evaluated for precision, recall, and/or F1 score.

12. The system of claim 8, wherein the computer program is further configured to use one or more algorithm to match the non-standard data elements to standard data elements using the machine learning model.

13. The system of claim 8, wherein the computer program is further configured to receive, from a user interface, a query for a mapping of one of the data elements to other data elements, to identify one of the standard data elements that matches the data element in the query, to retrieve the other data elements that are matched to the identified standard data element, and to display a mapping of the other data elements and the data element that are matched to the identified data element.

14. The system of claim 8, wherein the computer program is further configured to prompt a large language model for a name for the non-standard data element, the prompt comprising the non-standard data element and the description for the matching standard data element, and to receive, from the large language model, the name for the non-standard data element.

15. A non-transitory computer readable storage medium, including instructions stored thereon, which when read and executed by one or more computer processors, cause the one or more computer processors to perform steps comprising:
collecting a plurality of application programming interface (API) datasets, each API dataset identifying data elements used by the API, descriptions of the data elements, and datatypes for the data elements, wherein the API datasets are collected from a plurality of different industries;
splitting the API datasets into a training API dataset and a validation API dataset;
labeling the data elements in the training API dataset using standard data elements, wherein the standard data elements are defined by an organization for use by the organization;
training a machine learning model with the training API dataset and the labels to match the data elements to the standard data element;
evaluating the machine learning model using the validation API dataset;
integrating the machine learning model into a workflow to match a non-standard data element in a new API dataset to one of the standard data elements; and
using the non-standard data element in the same manner as the matching standard data element.

16. The non-transitory computer readable storage medium of claim 15, further including instructions stored thereon, which when read and executed by the one or more computer processors, cause the one or more computer processors to perform steps comprising:
pre-processing the API dataset by extracting, for each data element, a data element name, the description, and the datatype.

17. The non-transitory computer readable storage medium of claim 15, wherein the machine learning model is evaluated for precision, recall, and/or F1 score.

18. The non-transitory computer readable storage medium of claim 15, further including instructions stored thereon, which when read and executed by the one or more computer processors, cause the one or more computer processors to perform steps comprising:
creating one or more algorithm to match the non-standard data elements to standard data elements using the machine learning model.

19. The non-transitory computer readable storage medium of claim 15, further including instructions stored thereon, which when read and executed by the one or more computer processors, cause the one or more computer processors to perform steps comprising:
receiving, from a user interface, a query for a mapping of one of the data elements to other data elements;
identifying one of the standard data elements that matches the data element in the query;
retrieving the other data elements that are matched to the identified standard data element; and
displaying a mapping of the other data elements and the data element that are matched to the identified data element.

20. The non-transitory computer readable storage medium of claim 15, further including instructions stored thereon, which when read and executed by the one or more computer processors, cause the one or more computer processors to perform steps comprising:
prompting a large language model for a name for the non-standard data element, the prompt comprising the non-standard data element and the description for the matching standard data element; and
receiving, from the large language model, the name for the non-standard data element.
